(19) United States
(12) Patent Application Publication
(10) Pub. No.: US 2004/0144442 A1
(43) Pub. Date: Jul. 29, 2004

(54) Tube for feeding fastening elements for a fastening apparatus

(76) Inventors: Alain Vetoretti, Bourge Les Valence (FR); Patrick Herelier, Saint Jean De Muzols (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/694,386

(22) Filed: Oct. 28, 2003

(30) Foreign Application Priority Data
Oct. 30, 2002 (FR) 02 13597

(51) Int. Cl. F16L 9/00

(52) U.S. Cl. 138/177; 138/DIG. 11; 138/38

(57) ABSTRACT

The sealing apparatus (100) is used in a substantially vertical position by the user, who inserts a magazine pack containing nails into the hopper (101). After unlocking of the hopper (101), the nails slide in the flexible feed tube (10) as far as the front of a feeder for indirect firing, in a buffer guide (102). The user then merely has to actuate a trigger (103) in order to entrain the nails into the support via the feeder. In order to preserve the transparent quality of the tube (10), its effective inner cross section (21) is not circular, but is arranged (23) such that the contact between the lateral wall of the circular head of the nail (1) and the effective inner wall (21) of the tube (10) is not possible on certain portions (22) of the effective inner wall (21).

The invention relates to a fastening apparatus for inserting fastening elements in a support material such as an indirect-firing sealing apparatus that an operator is able to use while standing, for example for fastening a roofing panel to a roof.

The application applies to all types of fastening apparatus that use fastening elements that have a head and a stem. It therefore applies particularly to sealing apparatuses for embedding nails or, alternatively, to automatic screwdrivers for screwing in screws. The remainder of the description will often make reference to sealing apparatuses, but the applicant intends no limitation to this type of apparatus.

Thus, in an indirect-firing sealing apparatus, the nails are inserted into the gun of the apparatus, forward of the feeder, via a flexible feed tube extending between the downstream gun and an upstream hopper, which hopper is intended for receiving a magazine pack of nails that is dropped into and slid along the tube after the bottom of the hopper has been unlocked.

The flexible feed tubes are made from a transparent material so that the filling status of the feed tube can be ascertained. In point of fact, after a certain period of use and therefore of friction from the nails, essentially via their circular head, against the inner wall of the tube, this wall becomes opaque.

The present invention aims to preserve the transparent quality of the feed tube.

To this end, the invention relates to a tube, for feeding fastening elements with a circular head, for a fastening apparatus, made from transparent material, characterized in that its effective inner cross section is not circular.

Owing to the non-circular nature of the cross section of the tube, part of its inner wall escapes contact with the heads of the fastening elements when they slide in the tube, and it thus remains transparent.

In an advantageous embodiment, the inner wall of the tube is ribbed longitudinally, it being possible for the ribs to be attached to an original inner wall of circular cross section in the form of beading made from a material other than that of the tube.

In another embodiment, the inner cross section of the tube is substantially polygonal, for example triangular.

In yet another embodiment, the inner cross section of the tube has a substantially rounded-star shape.

The invention will be better understood with the aid of the following description of the preferred embodiments of the tube of the invention, with reference to the appended drawing, in which:

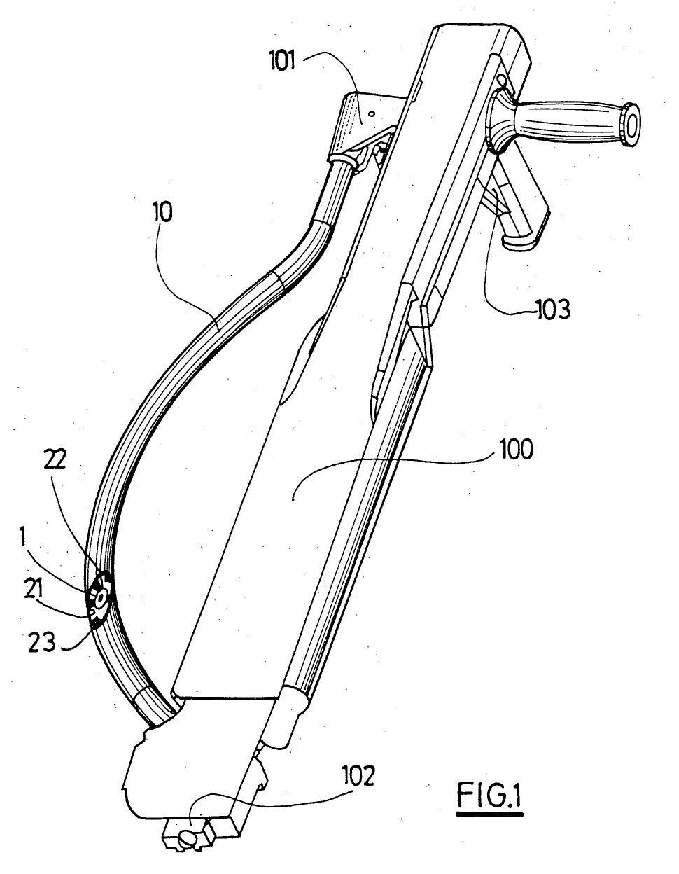

FIG. 1 shows a sealing apparatus with a tube of the present invention;

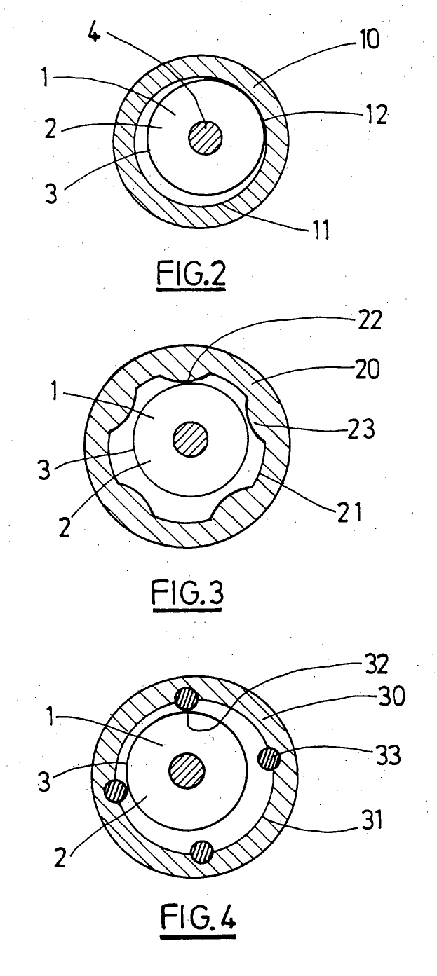

FIG. 2 shows a sectional view of a tube of the prior art, with a nail;

FIG. 3 shows a sectional view of a first embodiment of the tube of the present invention;

FIG. 4 shows a sectional view of a second embodiment of the tube of the present invention;

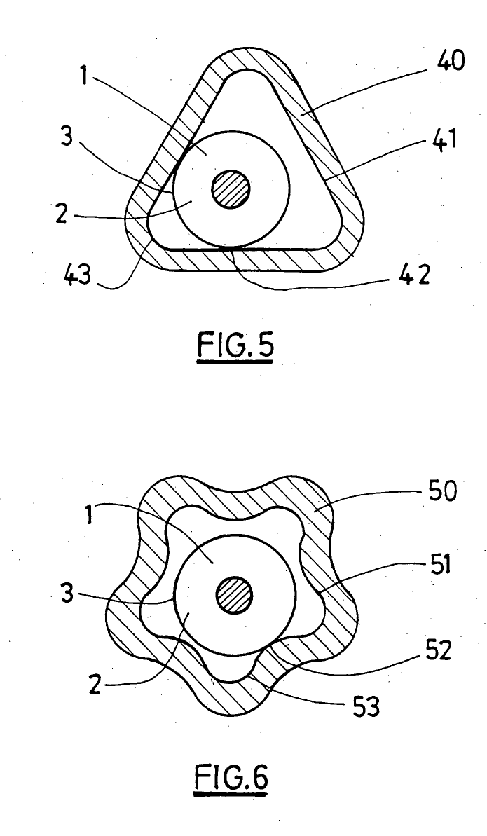

FIG. 5 shows a sectional view of a third embodiment of the tube of the present invention; and

FIG. 6 shows a sectional view of a fourth embodiment of the tube of the present invention.

With reference to FIGS. 1 and 2, the sealing apparatus 100, which is the example of a fastening apparatus considered in this case, is used in a substantially vertical position by the user who is able to place a magazine pack containing nails 1 in a hopper 101 provided for this purpose. After unlocking of the hopper 101, the nails 1 slide in a flexible tube 10 as far as the front of a feeder, for indirect firing, in a buffer guide 102. The user then simply has to actuate a trigger 103 in order to entrain the nails into the support via the feeder.

With reference to FIG. 2, when a nail 1 with a circular head 2 and a stem 4 slides in the tube 10, namely, in this case, a tube 10 with a circular effective inner cross section 11, the entire inner surface 11 of the tube 10 is likely to be in contact (12) with the lateral surface 3 of the circular head 2 of the nail 1. Therefore, even if the diameter of the circular head 2 of the nail 1 is smaller than that of the circular inner cross section of the tube 10, there may be surface contact 12 between the lateral surface 3 of the circular head 2 of the nail 1 and the inner surface 11 of the tube 10, it being possible for this contact surface 12 statistically to occupy any portion of the inner surface 11 when the nail 1 slides. Thus, the entire inner surface 11 of the tube 10 is likely, as nails 1 pass through, to enter into contact with the circular head 2 of a nail 1. The entire inner wall 11 of the tube 10 will thus be damaged by this passing-through and become opaque.

The present invention aims to require the nail 1 to make contact with certain inner portions of the tube, enabling the rest of the inner surface to remain transparent.

Thus, with reference to FIG. 3, the effective inner wall 21 of a tube 20 is ribbed longitudinally, the ribs 23 being shaped so that the contact 22 between the lateral wall 3 of the circular head 2 of the nail 1 and the effective inner wall 21 of the tube 20 occurs only at the longitudinal ribs 23. The inner surface 21 will therefore become opaque only at the ribs 23. The ribs 23 are in this case directly injection-moulded together with the rest of the inner wall 21 of the tube 20 and are made from the same material as that of the tube 20.

Reference has been made to the component elements of FIG. 3 in section in FIG. 1 in order to facilitate understanding of the invention.

With reference to FIG. 4, provision may be made for an original tube 30 with a circular inner cross section to which beadings 33, made from a material other than that of the tube 30, are attached, forming longitudinal ribs 33. Thus, the effective inner surface 31 of the tube 30 is the result of the combination of the initial circular inner surface and of the inner surface of the beadings. It is in fact the initial inner surface, except at the locations of the beadings 33, where the inner surface taken into account is that of the beadings 33, until said surface is further away from the centre of the tube than the initial inner surface. This results in the lateral wall 3 of the circular head 2 of the nail 1 being able to enter into contact (32) with the effective inner surface 31 of the tube 30 only at the beadings 33. The inner surface 31 will therefore become opaque only at the beadings 33.

With reference to FIG. 5, it is possible to use a tube 40 with an effective inner cross section 41 of substantially polygonal shape, in this case a substantially triangular shape. The dimensions of the tube 40 are configured so that the lateral wall 3 of the circular head 2 of the nail 1 can never enter into contact (42) with the dihedra 43 of the inner surface 41 of the tube 40. The inner surface 41 will therefore not become opaque at the dihedra 43. The choice of dimensions of the tube 40 obviously affects the proportion of inner surface 41 that never enters into contact with the nails 1.

With reference to FIG. 6, it is also advantageous to use a tube 50 with an effective inner cross section 51 of substantially rounded-star shape. The tube 50 is in this case configured so that the lateral wall 3 of the circular head 2 of the nail 1 can never enter into contact (52) with the rounded dihedra 53 of the star shape. The inner surface 51 will therefore not become opaque at the dihedra 53.

By virtue of the various embodiments of the invention described above, it is always possible to preserve, on the wall of the tube, transparent portions right along the tube. It goes without saying that any other shape of effective inner cross section can be envisaged for the tube, as long as it allows certain portions to escape any contact with the lateral wall 3 of the head 2 of the nails 1.

It will be noted that the inner cross section of the tube of the invention may be effective either for the nails or for the operator. In fact, both notions have been taken into account in order, by “effective”, to imply “actual”.

1. Tube (20, 30, 40, 50), for feeding fastening elements (1) with a circular head (2), for a fastening apparatus (100), made from transparent material, characterized in that its effective inner cross section (21, 31, 41, 51) is not circular.

2. Tube (20, 30) according to claim 1, in which the inner wall (21, 31) is ribbed longitudinally (23, 33).

3. Tube (20) according to claim 2, in which the ribs (23) are made from the same material as that of the tube (20).

4. Tube (30) according to claim 2, in which the ribs (33) comprise beadings (33) made from a material other than that of the tube (30).

5. Tube (40) according to claim 1, in which the inner cross section (41) is of substantially polygonal shape.

6. Tube (40) according to claim 5, in which the inner cross section (41) is of substantially triangular shape.

7. Tube (50) according to claim 1, in which the inner cross section (51) has a substantially rounded-star shape.
